(19) United States
(12) Patent Application Publication
(10) Pub. No.: US 2008/0239758 A1
(43) Pub. Date: Oct. 2, 2008

(54) Snap-in lamp for an electric light string

(76) Inventor: Kai Kong Ng, Kwai Hing (HK)

Correspondence Address: JACOBSON HOLMAN PLLC, 400 SEVENTH STREET N.W., SUITE 600, WASHINGTON, DC, 20004, US

(21) Appl. No.: 11/727,244

(22) Filed: Mar. 26, 2007

(51) Int. Cl. H01R 33/00

(52) U.S. Cl. 362/659

(57) ABSTRACT

A snap-in lamp for an electric light string includes a lamp base housing a light bulb and a lamp holder. The lamp base is removably and frictionally housed in the lamp holder. The light bulb has a filament that illuminates the light bulb when electrical current passes through the filament. The light bulb filament is connected to a bottom portion of the lamp base by a pair of opposed lead wires. The lamp holder is dimensioned to frictionally receive and removably house the lamp base. The lamp holder includes a metal conductor strap and a non-conductive strap holder that provide a path for the continued flow of current through the lamp even when the lamp base is removed from the lamp holder. The lamp is more useful than conventional lamps by virtue of the ability to preserve the closed circuit even when one or more lamp bases are removed from their respective lamp holders.

### BACKGROUND OF THE INVENTION

1. Field of the Invention

The present invention relates generally to a lamp for an electric light string. More particularly, the present invention relates to a lamp that is capable of maintaining an electrical connection to the remainder of the light string even when an individual light bulb is removed from the string.

2. Description of the Prior Art

Lamps for electric light strings, such as holiday lights, are well known. They typically include a removable light bulb mounted in a lamp base and a lamp holder or light socket assembled into the light string which receives the light bulb base. The filament in the light bulb can fail over time, however, and the bulb must be replaced. In the conventional lighting, when the filament fails and the bulb remains in the string, or when the bulb is removed from its socket for replacement, the closed path for the flow of electrical current is interrupted and the remainder of the lamps in the string will no longer be illuminated.

U.S. Pat. No. 6,257,740 addresses the above-described problem by disclosing a lamp designed to maintain a closed circuit even when a bulb is removed from the string. The '740 patent discloses a lamp having a light bulb, a light bulb base, and a light socket with two biased spring terminals. When the light bulb base is seated in the socket, the spring terminals are forced apart by a projecting separator on the light bulb base so as to provide contact between each of the spring terminals and a corresponding lead wire on the bottom of the light bulb base. This connection between the spring terminals and the light bulb base lead wires provides the path for electrical current to light the light bulb. When the light bulb base is removed from the light socket, the spring terminals spring together so as to contact one another. This connection between the spring terminals then provides the closed path for electrical current to flow so that the remainder of the light string receives current even when the light bulb has been removed from its light pocket.

A problem associated with the device disclosed by the '740 patent, however, is that after the light bulb base has been housed in the socket for a period of time, the spring terminals do not always fully spring back together upon removal of the light bulb base from the socket. That is, the spring terminals may partially spring together, but not to the extent necessary to contact one another. As a result, the light string is short circuited, and none of the lamps in the string is illuminated.

Another design that seeks to overcome the short-circuiting problem of conventional light strings is a prior art lamp having a light bulb, a light bulb base, and a light socket with two opposed terminals. In this design, the upper ends of the terminals extend across the width of the socket to approach, but not contact, one another. The socket also has a compressible metal coil spring aligned vertically on a post in the center of the socket. When the light bulb base is seated in the socket, the coil spring is compressed by a projection on the light bulb base, and each of the terminals contacts a corresponding lead wire on the bottom of the light bulb base. This connection between the terminals and the lead wires of the light bulb base provides the path for electrical current to light the bulb. When the light bulb base is removed from the light socket, the coil spring expands upward so as to contact each end of the opposed terminals. The uncompressed spring forms a bridge connection between the terminals and provides the closed path for electrical current to flow so that the remainder of the light string continues to receive current.

A problem associated with the above prior art device, however, is similar to that associated with the device of the '740 patent. That is, after the light bulb base has been housed in the socket over a period of time, the coil spring loses its resiliency and does not expand sufficiently to contact each end of the socket terminals. As a result, the light string is short circuited, and none of the lamps in the string is illuminated. In addition, since the coil spring is of iron construction, it will create a certain amount of heat while bridging the terminals. This generated heat can lead to overheating of the lamp, and ultimately, failure of the light string.

### SUMMARY OF THE INVENTION

In order to overcome the above-described draw-backs associated with prior art lamps, the present invention provides a snap-in lamp for a light string which includes generally a light bulb, a lamp base and a lamp holder. The light bulb is mounted in the lamp base which is removably and frictionally received in the lamp holder. The light bulb has a filament that illuminates the light bulb when electrical current passes through the filament. The light bulb filament is connected to a bottom portion of the lamp base by a pair of opposed lead wires.

The lamp base has an upper section and a lower section that depends therefrom. A pair of tapered prongs extend downwardly from the bottom of the lower section. Each prong includes a corresponding dumet lead wire that terminates at and contacts, at an uppermost end or light bulb-end of each dumet lead wire, a corresponding end of the light bulb filament.

The lamp holder includes a housing that defines a socket dimensioned to receive the lamp base. A pair of electrical terminal wires extend into opposite sides of the socket and terminate in a pair of opposed terminals. A pair of opposed socket lead wires extend upwardly from the corresponding terminals and terminate along opposed side walls of the socket.

It is, therefore, an object of the present invention is to provide a snap-in lamp that maintains the light string in a closed circuit mode even when one or more light bulb bases are removed from their respective sockets. Therefore, according to a preferred embodiment of the present invention, the lamp holder includes a metal conductor strap that provides a path for the continued flow of current through the lamp even when the lamp base is removed. The metal conductor strap is mounted on a non-conductive strap holder and has an arch or inverted U-shape such that the strap can be seated in and supported by the strap holder. The strap has a pair of opposed contact legs capable of engaging the corresponding terminals when the light bulb is removed. The strap has elastic properties such that the contact legs are capable of spring-like flexing both toward and away from the strap holder.

Another object of the present invention is to provide a lamp base that has two prongs which extend downwardly therefrom for insertion into corresponding slots or receptacles, so that each of the two prongs can contact and move a respective contact leg of the conductor strap. Therefore, according to the preferred embodiment of the present invention, the socket of the lamp holder is configured to slidably and frictionally engage and house the lamp base with each prong extending into a slot located between each terminal and the strap holder. Each of the prongs thus slidably engages the respective contact leg of the conductor strap and disengages the contact leg from contact with its respective terminal.

Hence, when the lamp base is housed in the lamp holder, each prong of the lamp base is inserted in a slot or receptacle in the socket and each contact leg is accordingly compressed inwardly toward the strap holder and out of contact with the terminal. In this “lamp base-in” configuration, therefore, electrical current flows from the terminal to the socket lead wire, to the dumet lead wire, and to the filament. Current then flows from the opposed end of the filament to the opposed dumet lead wire, to the opposed socket lead wire, to the opposed terminal, and out of the lamp to the next lamp in the string.

The contact legs are biased with sufficient force so as to spring apart from one another when not compressed by the prongs of the lamp base. Therefore, when the lamp base is removed from the lamp holder, the prongs are withdrawn from the socket slots and each contact leg accordingly springs outward away from the strap holder and into contact with its respective terminal. In this “lamp base-out” configuration, electrical current flows from the terminal to the contact leg, through the strap to the opposed contact leg, to the opposed terminal, and out of the lamp to the next lamp in the string.

Because the metal conductor strap possesses the aforementioned spring-like elasticity, even after the lamp base has been housed in the lamp holder for an extended period of time with the contact legs compressed and out of contact with the terminals, upon removal of the lamp base from the lamp holder, the contact legs will spring outwardly from the strap holder so as to once again contact the terminals and complete the circuit.

By virtue of the above-described configuration, the present light string lamp is more reliable than prior lamps because of the ability to maintain the closed circuit even when one or more lamp bases are removed from their respective lamp holders.

Other objects of the present invention are to provide a lamp that can be easily fabricated from readily available materials, that is reliable and has a long service life, that is safe for its intended use, and that provides for easy replacement of one or more bulbs while the light string remains in operation. Each of these objects is attained with the present invention.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a cut-away perspective view of a lamp according to a preferred embodiment of the present invention with the light bulb and lamp base removed from the lamp holder.

FIG. 2 is a perspective view of the lamp shown in FIG. 1 with the lamp base inserted in the lamp holder.

FIG. 3 is a perspective view of the strap holder of the lamp holder shown in FIG. 1.

FIG. 4 is a perspective view of the conductor strap of the lamp holder shown in FIG. 1.

FIG. 5 is a perspective view of the lamp base shown in FIG. 1.

FIG. 6 a perspective view of the housing of the lamp holder shown in FIG. 1.

FIG. 7 is a cross-section view of the lamp shown in FIG. 2 taken substantially along line 7-7 shown therein.

FIG. 8 is a cross-section view of the lamp shown in FIG. 2 taken substantially along line 8-8 shown therein.

### DETAILED DESCRIPTION OF THE PREFERRED EMBODIMENTS

Although only preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways.

Also, in describing the preferred embodiments, terminology will be resorted to for the sake of clarity. It is intended that each term contemplates its broadest meaning as understood by those skilled in the art, and includes all technical equivalents which operate in a similar manner to accomplish a similar purpose.

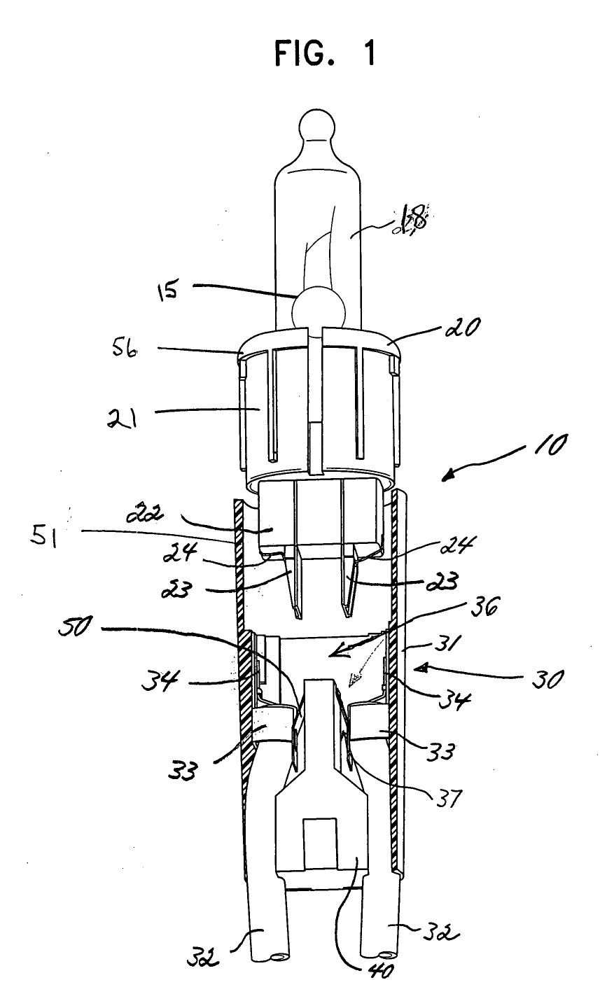

Referring to FIG. 1 of the drawings, a snap-in lamp according to a preferred embodiment of the present invention is generally designated by reference numeral 10. The lamp 10 includes generally a lamp base 20 that is removable from a lamp holder, generally designated by reference numeral 30. The lamp base 20 houses a light bulb 18. The light bulb 18 has a filament 15 that illuminates the light bulb when electrical current passes through the filament.

The lamp base 20 has an upper section 21 and a lower section 22 that depends therefrom. A pair of tapered prongs 23 extend downwardly from the lower section 22, and each prong 23 includes a corresponding dumet lead wire 24. Each dumet lead wire 24 has one end embedded in the base 20 which is in electrical contact with a corresponding end of the light bulb filament 15. The other end 24A of dumet lead wires 24 are exposed and extend upwardly on opposite sides of the lamp base lower section 22. The outside surface of each prong 23 tapers from top to bottom so that the prong 23 is narrowest at its bottom end. The angular shape of the prongs 23 facilitates their slidable engagement into the lamp holder 30, as will be described hereinafter.

The lamp holder 30 includes a housing 31 which defines a socket generally designated by referenced numeral 36, that is dimensioned to receive the lamp base 20. A pair of electrical terminal wires 32, preferably of conventional copper construction, extend into opposite sides of the socket 36 and terminate in a pair of opposed terminals 33, also preferably of conventional copper construction. A pair of opposed socket lead wires 34 extend upwardly from the corresponding terminals 33 and terminate along opposed side walls of the socket 36. When the lamp base 20 is inserted into the socket 36, each socket lead wire 34 contacts the corresponding exposed end 24A of dumet lead wire 24.

The terminal wires 32 and terminals 33 are separated by an insertable non-conductive strap holder 40, which has mounted at the top thereof a metal conductor strap 50. As described in greater detail below, when power is “on” between terminal wires 32 and the lamp base 20 is housed in the lamp holder 30, electrical current flows from one terminal wire 32 through its terminal 33 to the socket lead wire 34, to the dumet lead wire 24 and to the filament. The current follows the reverse path on the opposed side of the lamp. When lamp base 20 is removed from the socket 36, the conductor strap 50 contacts and makes electrical connection with the opposed terminals 33, thus completing the circuit so that current can flow from one terminal wire 32 to the opposed terminal wire 32.

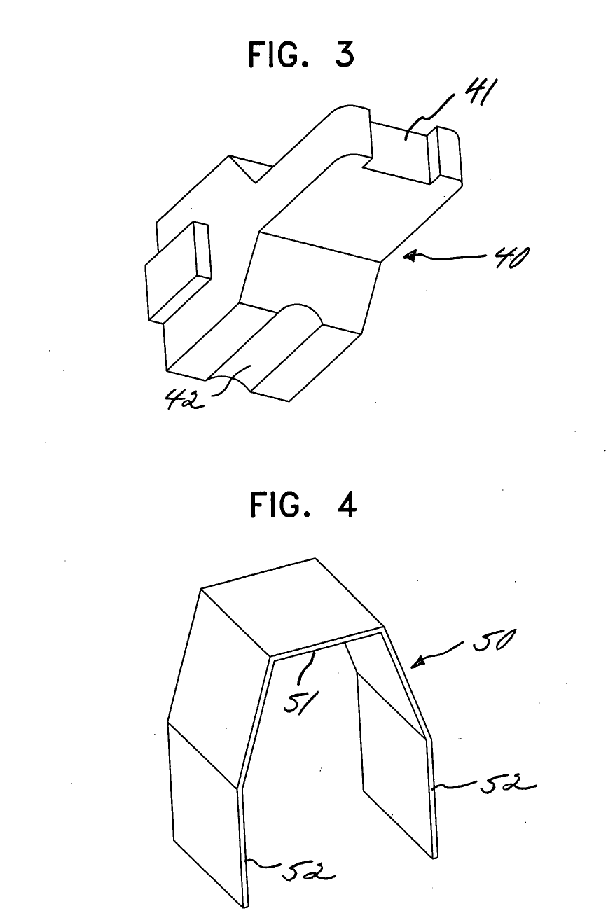

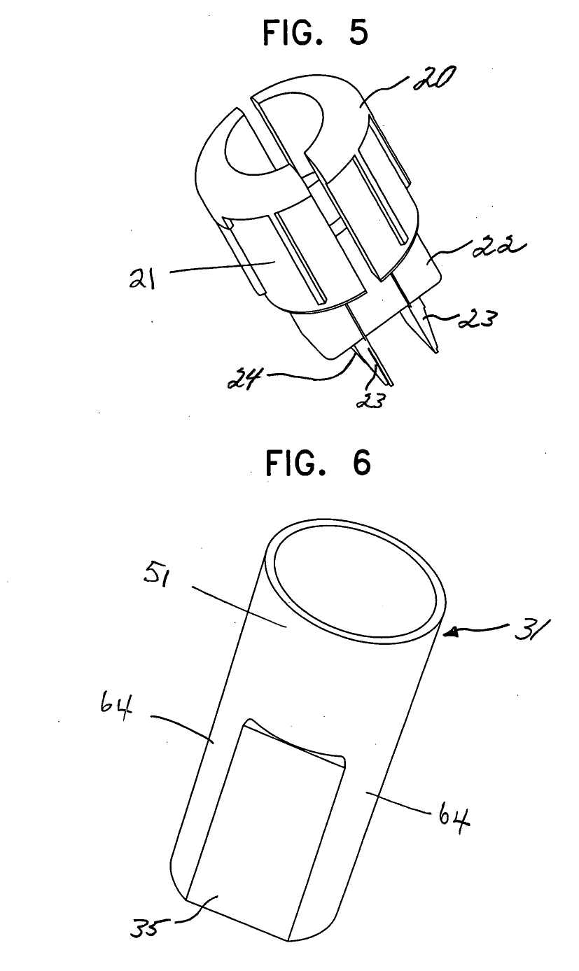

As shown in FIG. 1 and in detail in FIG. 3, the non-conductive strap holder 40 is dimensioned to house and support the metal conductor strap 50. The strap holder 40, preferably of constructed of a molded polymeric or other suitable material, includes a conductor strap recess 41 and a pair of opposed terminal wire recesses 42. Once inserted in the lamp holder 30, the strap holder 40 is held in place by contact among the opposed terminal wires 32, the corresponding opposed terminal wire recesses 42 and the inside wall of the housing 31, as described further below.

As shown in FIG. 4, the metal conductor strap 50 has an arch or inverted U-shape such that the strap 50 can be seated in the recess 41 and supported by the strap holder 40. The strap 50 has a seating face 51 that engages the recess 41, and a pair of opposed contact legs 52 capable of engaging the corresponding terminals 33. Preferably of copper construction to match that of the terminal wires 32 and the terminals 33, the strap 50 has elastic properties such that the contact legs 52 are capable of spring-like flexing both toward and away from the strap holder 40.

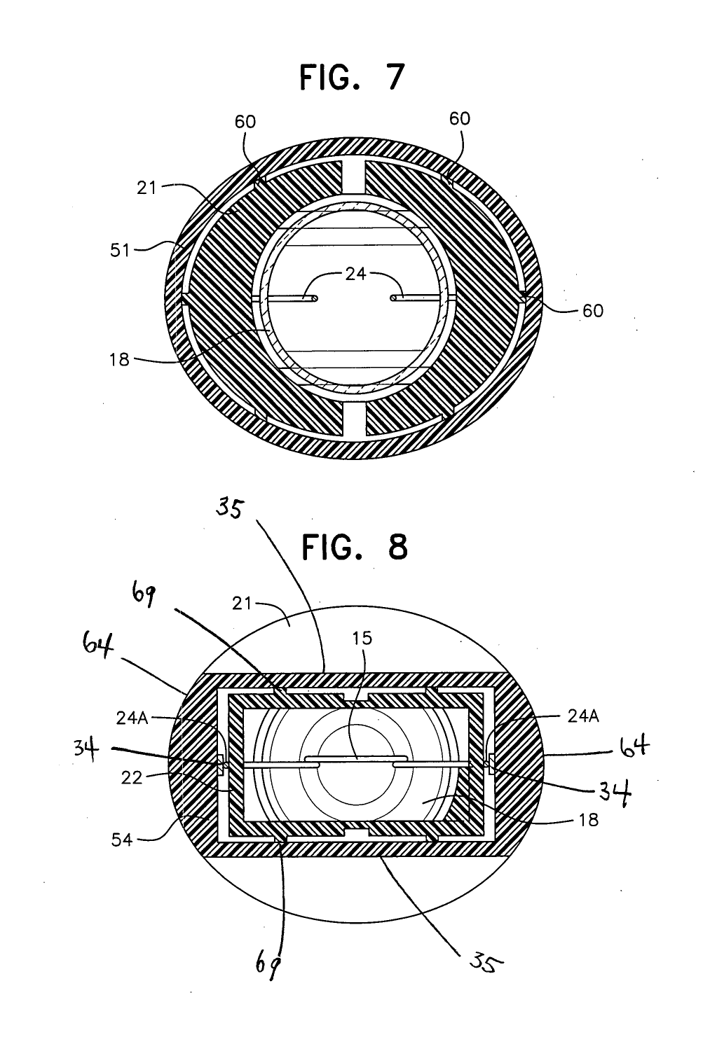

The socket 36 of lamp holder 30 is configured to frictionally engage and house the lamp base 20 when the lamp base is slide into the lamp holder socket 36. More specifically, the upper section 21 of lamp base 20 preferably has a generally oval shape in cross-section, which is matched by the open upper end 51 of the housing 31. See FIG. 7. This oval shape facilitates alignment of the lamp base 20 for insertion into the lamp holder 30. The lamp base lower section 22 has a generally rectangular shape in cross-section which is configured to frictionally fit within the top of lower section 54 of the housing 31. See FIG. 8. The top of lamp base 20 also preferably has a protruding rim 56 at its upper edge which engages the upper edge 58 of housing 31 to ensure that the lamp base does not over-extend into the lamp holder. The lamp base upper section 21 also preferably has a plurality of raised ribs 60 extending axially around the outer surface. The ribs 60 facilitate sliding movement, with less friction of the lamp base upper section 21 within the lamp holder upper end 51.

The lower section 54 of the housing 31 of the lamp base 30 has flattened sides 35 which form a generally rectangular shape, with rounded sides 64. Lower section 54 is thus configured to frictionally receive the lower section 22 of lamp base 20 in the upper end 66 of section 54. The lamp base lower section 22 also has raised axial ribs 69 to reduce friction when section 22 is inserted into or extracted from end 66 of the housing lower end. The lower end 68 of housing section 54 frictionally receives the strap holder 40 with the opposed terminal wires 32 secured in recesses 42 of the strap holder 40 against the inside surfaces 70 of the rounded sides 64.

The flattened sides 35 in the lower section 54 of the lamp holder 30 serve as convenient gripping surfaces for a thumb and forefinger to hold the lamp holder when inserting or extracting the light bulb and lamp base from the socket 36 of the lamp holder. The lamp base 20, the lamp holder housing 31 and the strap 40 can be made from any suitable injection molded polymeric material, such as PE (polyethylene), PP (polypropylene), PVC (polyvinyl chloride), PET (polyethylene terephthalate), ABS (acrylonitrile butadiene styrene), AS (acrylonitrile styrene), PS (polystyrene), PC (polycarbonate), etc., for ease of manufacture and desired rigidity with some elasticity to achieve the requisite frictional engagement of the component parts. Polypropylene is currently preferred.

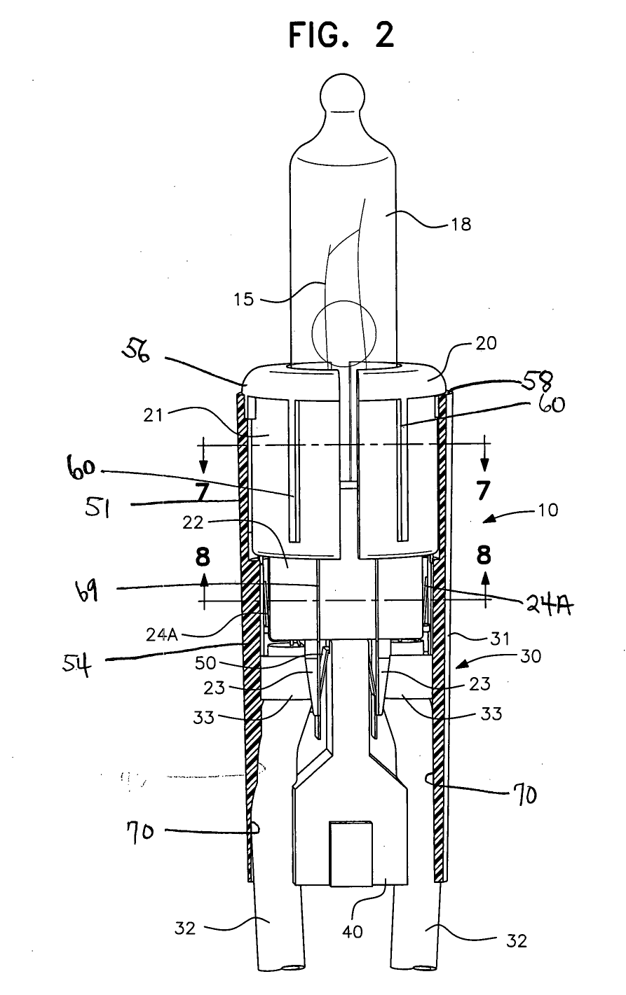

When the lamp base 20 is inserted into the lamp holder 30, the lamp base lower section 22 is seated in the lower section 54 of the housing 31 such that each of the prongs 23 is inserted into a corresponding slot or receptacle 37 located between each terminal 33 and, the strap holder 40. Each of the prongs 23 slidably engages the respective contact leg 52 of the conductor strap 50 and disengages the contact leg 52 from physical, and thus electrical, contact with its respective terminal 32. That is, as shown in FIG. 2, when the lamp base 20 is housed in the lamp holder 30, each prong 23 is inserted into a slot or receptacle 37 and each contact leg 52 is accordingly compressed inward toward the strap holder 40 and out of contact with the terminal 33. In this “lamp base-in” configuration, therefore, electrical current flows from the terminal 33 to the socket lead wire 34, to the dumet lead wire 24, and to the filament. Current then flows from the opposed end of the filament to the opposed dumet lead wire 24 through the opposed socket lead wire 34 to the opposed terminal 33, and out of the lamp 10 to the next lamp in the string.

The contact legs 52 are biased outwardly with sufficient force so as to spring apart from one another when not compressed by the prongs 23. Therefore, as shown in FIG. 1, when the lamp base 20 is removed from the lamp holder 30, each prong 23 is withdrawn from its corresponding slot 37 and each contact leg 52 accordingly springs outward away from the strap holder 40 and into contact with the terminal 33. In this “lamp base-out” configuration, electrical current flows from the terminal 33 to the contact leg 52, through strap 50 to the opposed contact leg 52, to the opposed terminal 33, and out of the lamp 10 to the next lamp in the string.

Therefore, the strap 50 necessarily possesses the aforementioned spring-like elasticity such that even after the lamp base 20 has been housed in the lamp holder for an extended period of time with the contact legs 32 compressed and out of contact with the terminals 33, upon removal of the lamp base 20 from the lamp holder 30, the contact legs 32 will spring outwardly from the strap holder 40 so as to once again contact the terminals 33 and complete the circuit. That is, the strap 50 must have an elastic limit such that even after the contact legs 32 have been compressed for an extended period of time, upon removal of the lamp base, the contact legs 32 are not permanently deformed but instead spring outward, returning strap 50 to the uncompressed shape shown in FIG. 4.

According to another embodiment of the invention, a light string includes a plurality of the above-described lamps 10 and the associated interconnecting wiring and power supply plug. In an optional embodiment, the light string includes a power plug receptacle on the end of the string opposite the power supply plug. This feature enables individual light strings to be connected in series.

The foregoing is considered as illustrative only of the principles of the invention. Further, since numerous modifications and changes may readily occur to those skilled in the art, it is not desired to limit the invention to the exact construction and operation described and shown. Accordingly, all suitable modifications and equivalents may be resorted to that fall within the scope of the invention as defined by the following claims.

What is claimed is:

1. A lamp for an, electric light string, comprising:
a lamp base housing a light bulb, the lamp base having a pair of opposed bulb lead wires depending therefrom; and
a lamp holder removably housing the lamp base, the lamp holder including a socket that frictionally receives the lamp base, a pair of metal terminal wires extending into opposite sides of the socket and terminating in a pair of opposed terminals, a pair of opposed socket lead wires extending from the corresponding terminals for electrical contact with said pair of opposed bulb lead wires, and a metal conductor strap supported by a strap holder and being in contact with each of the opposed terminals when the lamp base is removed from the lamp holder so as to provide a closed circuit.

2. The lamp according to claim 1, wherein the conductor strap includes a pair of opposed flexible contact legs capable of elastic deformation both toward and away from the strap holder.

3. The lamp according to claim 2, wherein the contact legs flex such that when the lamp base is housed in the lamp holder, each of the contact legs is compressed inward toward the strap holder and out of contact with the respective terminal, and when the lamp base is removed from the lamp holder, each of the contact legs springs outward away from the strap holder and into contact with the respective terminal.

4. The lamp according to claim 1, wherein the strap holder includes a conductor strap recess that houses the conductor strap and a pair of opposed terminal wire recesses, the strap holder being held in place in said lamp holder by frictional contact among the opposed terminal wires, the corresponding opposed terminal wire recesses and an inside wall of said lamp holder.

5. The lamp according to claim 1, wherein the conductor strap has an arch or inverted U-shape such that the strap is seated in and supported by the strap holder.

6. The lamp according to claim 2, wherein the contact legs are biased with sufficient force so as to spring apart from one another and contact the respective terminals after the lamp base has been housed in the lamp holder for an extended period of time.

7. The lamp according to claim 1, wherein the conductor strap is of copper construction, and the strap holder is of polymeric construction.

8. The lamp according to claim 2, wherein when the lamp base is housed in the lamp holder, a closed path for electrical current is provided from one of the terminals to the socket lead wire through the dumet lead wire and to the light bulb, and from the opposed dumet lead wire through the opposed socket lead wire to the opposed terminal and out of the lamp to the next lamp in the string.

9. The lamp according to claim 2, wherein when the lamp base is removed from the lamp holder, a closed path for electrical current is provided from one of the terminals to an adjacent one of the contact legs, through the strap to the opposed contact leg, to the opposed terminal, and out of the lamp to the next lamp in the string.

10. The lamp according to claim 1, wherein the lamp base includes a two prongs depending therefrom, with each of the dumet lead wires attached to a corresponding prong, and wherein the socket is configured to slidably engage and house the two prongs.

11. The lamp according to claim 10, wherein when the lamp base is seated in the lamp holder socket, each prong is seated in a slot located between each of the terminals and the strap holder.

12. The lamp according to claim 10, wherein each of the prongs tapers from top to bottom so that each prong is narrowest at a bottom end.

13. The lamp according to claim 12, wherein each of the prongs slidably engages the respective contact leg of the conductor strap and disengages the contact leg from contact with the respective terminal.

14. A lamp for an electric light string, comprising:
a lamp base housing a light bulb, the lamp base having an upper section, a lower section and two prongs depending from said lower section, each prong including a corresponding dumet lead wire in electrical contact with filament wires of said light bulb; and
a lamp holder removably housing the lamp base therein, the lamp holder including a housing defining a socket that receives the lamp base, a pair of metal terminal wires extending into opposite sides of the socket and terminating in a pair of opposed terminals, a pair of opposed socket lead wires extending upward from the corresponding terminals, and a metal conductor strap supported by a non-conductive strap holder, the conductor strap having a pair of opposed flexible contact legs capable of engaging the corresponding terminals,
such that, when the lamp base is housed in the lamp holder, each of the prongs compresses the contact legs inwardly toward the strap holder and out of contact with the respective terminal and, when the lamp base is removed from the lamp holder, each of the prongs is withdrawn and each of the contact legs springs outwardly away from the strap holder and into contact with the respective terminal so as to provide a closed circuit.

15. An electric light string comprising a plurality of the lamps according to claim 1, with the lamps connected in series.

16. The lamp according to claim 14, wherein said lamp holder housing includes an upper section and a lower section configured to frictionally receive said lamp base upper section and said lamp base lower section, respectively, when said lamp base is inserted into said lamp holder.

17. The lamp according to claim 16, wherein said lamp base upper section is generally oval in shape and said lamp base lower section is generally rectangular in shape and said socket defined by said housing has a corresponding oval shape in said housing upper section and a corresponding rectangular shape in said housing lower section.

18. The lamp according to claim 16, wherein said lamp base, said lamp holder housing and said strap holder are all made of a suitable molded polymeric material.

19. The lamp according to claim 16, wherein the lamp base upper section has a plurality of axially extending raised ribs around its outer surface to facilitate sliding movement of the lamp base upper section within the lamp holder housing upper section.

20. The lamp according to claim 17, wherein the generally rectangular lamp holder housing lower section defines flattened outer sides for gripping when holding the lamp holder for inserting or extracting the lamp base from the lamp holder.
